(19) United States
(12) Patent Application Publication
(10) Pub. No.: US 2003/0003202 A1
(43) Pub. Date: Jan. 2, 2003

(54) Method of preserving and disinfecting a food commodity

(75) Inventor: James T.C. Yuan, Naperville, IL (US)

Correspondence Address: Jasper W. Dockrey, Brinks Hofer Gilson & Lione, P.O. Box 10395, Chicago, IL, 60610, US

(73) Assignee: American Air Liquide Inc. and L`Air Liquide

(21) Appl. No.: 09/894,406

(22) Filed: Jun. 28, 2001

(51) Int. Cl. A23C 1/00

(52) U.S. Cl. 426/320

(57) ABSTRACT

A process for disinfecting and preserving a food commodity includes the steps of applying antimicrobial chemicals to the surface of the food commodity followed by subjecting the food commodity to a quick-chilling process. The chilling process creates a partial vacuum within the interior regions of the food commodity to create a driving force that assists the diffusion of the antimicrobial chemicals into the food commodity. In a preferred embodiment, the food commodity is chilled from about room temperature to about 10° C. or below in a period of time of less than about ten minutes. Once the chilling process is complete, the food commodity can be subjected to further processing steps, such as refrigeration or freezing, or other processing, such as cutting, sorting, and storage.

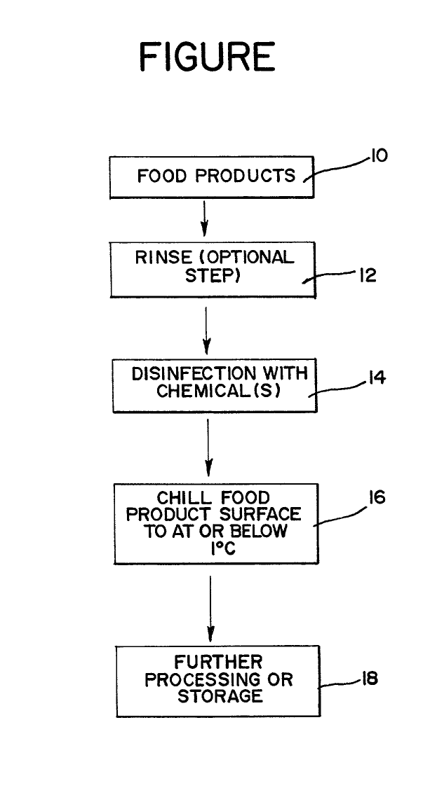

### FIELD OF THE INVENTION

The present invention relates, generally, to methods for preserving food commodities and, more particularly, to methods for disinfecting and preserving food commodities using a combination of chilling and chemical treatment.

### BACKGROUND OF THE INVENTION

The production of food commodities that do not prematurely spoil and that do not contain disease-causing microorganisms is an on-going goal of the food processing industry. Both food spoilage and food-borne diseases are caused by the presence of two types of microorganisms on food commodities. One type of micro-organism causes the food to spoil and the other type of micro-organism is a pathogenic micro-organism that can potentially lead to food-borne outbreaks of disease. Where a food commodity is contaminated by microorganisms causing spoilage, then the food product gets spoiled and must be discarded. However, if pathogenic microorganisms are present on a food commodity, then these organisms can potentially lead to food-borne outbreaks that pose significant risk to the human health. Outbreaks of pathogenic microorganisms, such as Salmonella and E. coli, cause millions of cases of food poisoning annually and, in extreme cases, high rates of human mortality. In view of the potential adverse effects on human health and the high cost associated with the destruction of food commodities, the food manufacturing industry continues to seek improved methods of food processing that reduce, and preferably eliminate pathogenic microorganisms from processed foods.

Both food spoilage and pathogenic microorganisms can originate from several sources, including the ingredients used in food products and from contact with contaminated food contact surfaces during food processing operations. Presently, food manufacturers use heat or chemicals to disinfect food products during manufacturing. Application of heat in the form of steam or hot water is a commonly used method for disinfecting food and for cleaning food contact surfaces. However, the efficiency of steam or hot water is low on large, exposed surface areas. Additionally, steam or hot water can adversely affect food products by thermally degrading the food products and by breaking down nutrients in the food products.

An alternative to thermal treatment is to apply disinfecting chemicals directly to the food products. For example, chlorine-based chemical agents are relatively effective against most microorganisms and reasonably inexpensive to apply. Additionally, ozone (O₃) has been shown to be a highly reactive oxidant capable of destroying many different kinds of microorganisms commonly found on food commodities. Although chemical agents can be readily applied to food commodities, each particular chemical has a corresponding specific range of activity with respect to the population of microorganisms commonly found on food products. Additionally, the effectiveness of many chemicals depends upon carefully maintained storage and operating conditions, and upon solution characteristics. For example, chlorine (Cl₂) is effective at a pH of about 6 to about 8, and becomes less effective outside of that pH range. Further, although ozone has been widely used as a disinfectant in the food industry for a number of years, ozone treatment processes lack effective means for delivering gaseous ozone or mixtures of gaseous and liquid ozone onto food products during the manufacturing process.

A limitation in the effectiveness of virtually all chemical treatments relates to the inability of chemicals to thoroughly detach microorganisms from the surface of the food commodity. In many cases, a significant portion of the microorganisms are firmly attached to the surface of the food commodity by a biofilm. Since the concentration of the chemical agents applied to the food product must necessarily be limited in order to avoid tainting the food, the concentration often is not high enough to produce sufficient chemical activity to penetrate the biofilm. Chemical activity is additionally limited by the available exposure time of the chemicals to the food commodity. Food processing times are necessarily reduced to maximize food freshness and quality. Accordingly, insufficient contact time limits the ability of the applied chemicals to thoroughly penetrate the microorganisms biofilm and effectively kill all the microorganisms.

Given the extreme importance of reducing and, ideally, eliminating microorganisms in food products, further development of food disinfection and preservation technology is needed. In particular, methodologies are required that effectively kill microorganisms present on food, while maintaining efficient food manufacturing processes.

### BRIEF SUMMARY

The present invention is for a method of preserving and disinfecting a food commodity that includes the application of antimicrobial chemicals to the food commodity and subsequently chilling the food commodity. Once the food commodity is chilled, the food can be subjected to further processing steps, such as refrigeration, freezing or further food processing steps.

Preferably, the antimicrobial chemicals are applied in a gaseous or liquid form such that the chemicals coat the exterior surfaces of the food commodity. The antimicrobial chemicals can be any of a number of disinfecting chemicals, such as chemical compounds including a halogen, hydrogen peroxide, a phosphate group, an organic acid, ozone and the like.

The chilling process is preferably a cryogenic chilling process carried out with a liquefied gas, such as nitrogen and CO₂ and the like. Alternatively, a mechanical chilling process can also be used. Preferably, the chilling process is carried out, such that the temperature of the food commodity is reduced from about room temperature to a temperature just above the freezing point of the food commodity. Typically, this temperature is about 1° C. The chilling process is preferably carried out in a period of time of less than about ten minutes.

The method of the invention effectively reduces the population of microorganisms on the food commodity by combining the effects of chemical treatment with rapid chilling of the food commodity. The quick-chilling process minimizes the growth of microorganisms by retarding the growth functions and enhances the biocidal efficacy of the chemicals with respect to the microorganisms contaminating the food commodities.

### BRIEF DESCRIPTION OF THE DRAWING

The sole FIGURE of the drawing is a flowchart of a process in accordance with the invention for disinfecting and preserving a food commodity.

### DETAILED DESCRIPTION OF PREFERRED EMBODIMENTS

In accordance with the invention, a process for disinfecting and preserving a food commodity includes the steps of treating the food commodity with disinfecting chemicals either in a gaseous or liquid phase for a predetermined period of time. After the application of chemicals, the food commodity is chilled to a temperature just above the freezing point of the food commodity. Since most food commodities contain significant amounts of water, the process of the invention chills the food commodity to a temperature of about 10°C. and, more preferably, about 1° C. Preferably, the chilling process is carried out rapidly in order to quick-chill the food commodity. In accordance with the invention, the chilling process is carried out for a period of time of less than about 1 hour and, more preferably, less than about ten minutes and, more preferably, in about 1 to about 3 minutes.

Importantly, the quick-chilling process functions to create a vacuum in the interior regions of the food commodity. Accordingly, a pressure differential is established between the surface of the food commodity and the interior regions of the food commodity. By establishing a pressure differential, the diffusion of the disinfecting chemicals applied to the surface of the food commodity into the interior regions of the food commodity is enhanced. Thus, the quick-chilling process improves the biocidal efficacy of the chemicals applied to the surface of the food commodity by increasing the diffusion of the chemicals into the food commodity. The enhanced diffusion of chemicals assists the chemicals in breaking through the biofilm created by the microorganisms on the surface of the food commodity.

In one specific embodiment of the invention, an animal carcass having an interior cavity, such as poultry carcasses and the like, are treated with antimicrobial chemicals, then cold shocked by quick cryogenic chilling. The cold shock creates a local vacuum in the interior cavity of the carcass and establishes a pressure differential between the skin of the carcass and the interior cavity. The chemicals applied to the surface of the carcass then rapidly diffuse into the skin of the carcass under the assistance of the pressure differential. Accordingly, the antimicrobial chemicals can effectively penetrate the biofilm containing the microorganisms through a combined action of chemical activity and pressure induced diffusion.

The quick-chilling process of the invention can also be applied to other protein products, such as beef and seafood. The process of the invention is particularly effective with food products initially processed as an animal or fish carcass. The interior volume of such carcasses provides a volume in which a low pressure region can quickly be established. Preferably, the chilling process is carried out by means of cryogenic chilling using liquefied gases, such as nitrogen, CO₂ air and the like. The liquefied gases typically have a temperature on the order of about −100° C. or less.

A flowchart generally illustrating the process of the invention appears in the sole figure of the drawing. The food commodity can be a meat, such as beef or pork, a poultry product, such as chicken, goose, duck, and the like. Furthermore, the food products can be fish or seafood or the like.

Preferably, the rinsing process is carried out with potable water, which can include a surfactant such as polysorbate. In accordance with the invention, food products 10 are subjected to an optional rinsing process 12. The rinsing process 12 can be carried out with water at a temperature of about 1° C. to about 70° C.

Next, a chemical treatment 14 is applied to the food products. The chemicals can be applied as a gas, a liquid entrained in a gas, or in liquid form. The treatment chemicals include, but are not limited to, chlorine, chlorine dioxide, trisodium phosphate, ozone, hydrogen peroxide, organic acids and disinfectants, such as nisin and lactate, and the like. In addition to the chlorine, other halogens, such as fluorinated compounds and the like can also be used. Further, many different types of organic acids can be applied, such as lactic acid and the like. Chemical treatment processes useful in the present invention are described in commonly-assigned U.S. Pat. No. 6,066,348 and are hereby incorporated by reference.

Once antimicrobial chemicals are applied to the food products, the food products are subjected to a chilling process 16. Preferably, the food products are chilled to a temperature of about 1° C. or below. As previously described, preferably the chilling process is a cryogenic chilling process. However, other types of temperature reduction processes are contemplated by the present invention. For example, mechanical chilling processes can also be carried out. Further, the mechanical chilling processes can be performed either exclusively or in combination with a cryogenic chilling process. As described above, preferably, the chilling process is carried out in a short period of time such that a vacuum is created in the interior regions of the food products.

Once the antimicrobial chemicals have been applied and the food products have been chilled, further processing steps 18 can be carried out. For example, the further processing steps can include refrigeration or freezing or the like. Also, the food products can be subjected to additional food processing steps, such as cutting, cooking, sorting, packaging and the like.

Thus it is apparent that there has been disclosed in accordance with the invention, a method of preserving and disinfecting a food commodity. Although particular embodiments of the invention have been described, it will be apparent to one skilled in the art that numerous modifications and variations can be made to the presented embodiments, which still fall within the spirit and scope of the invention. Accordingly, it is intended that all such variations and modifications fall within the scope of the appended claims and equivalents thereof.

1. A method of preserving a food commodity comprising applying antimicrobial chemicals to the food commodity and, thereafter, chilling the food commodity.

2. The method of claim 1 further comprising subjecting the food commodity to a process selected from the group consisting of refrigeration, freezing and further food processing steps directly after chilling the food commodity.

3. The method of claim 1, wherein applying antimicrobial chemicals comprises applying liquid ozone.

4. The method of claim 1, wherein applying antimicrobial chemicals comprises contacting the food commodity with chemicals comprising a compound including a halogen.

5. The method of claim 4, wherein applying antimicrobial chemicals comprises contacting the food commodity with chemicals comprising a compound including chlorine.

6. The method of claim 1, wherein applying antimicrobial chemicals comprises contacting the food commodity with chemicals comprising a compound including a phosphate group.

7. The method of claim 1, wherein applying antimicrobial chemicals comprises contacting the food commodity with chemicals comprising hydrogen peroxide.

8. The method of claim 1, wherein applying antimicrobial chemicals comprises contacting the food commodity with chemicals comprising an organic acid.

9. The method of claim 8, wherein applying antimicrobial chemicals comprises contacting the food commodity with chemicals comprising lactic acid.

10. The method of claim 1, wherein applying antimicrobial chemicals comprises contacting the food commodity with chemicals selected from the group consisting of nisin and lactate.

11. The method of claim 1, wherein chilling the food commodity comprises cryogenic chilling.

12. The method of claim 11, wherein cryogenic chilling comprises chilling with a liquefied gas selected from the group consisting of nitrogen, CO₂ and air.

13. The method of claim 1, wherein applying antimicrobial chemicals comprises contacting the food commodity with a liquid chemical agent.

14. The method of claim 1, wherein applying antimicrobial chemicals comprises contacting the food commodity with an gaseous chemical agent.

15. The method of claim 1, wherein the food commodity is selected from the group consisting of meat, poultry and seafood.

16. The method of claim 1, wherein chilling the food commodity comprises reducing the temperature of the food commodity to about 10° C.

17. The method of claim 16, wherein chilling the food commodity comprises reducing the temperature of the food commodity to no more than about 1° C.

18. The method of claim 1, wherein chilling the food commodity comprises reducing the temperature of the food commodity to about the freezing temperature of the food commodity in a period of time of less than about one hour.

19. The method of claim 18, wherein chilling the food commodity comprises reducing the temperature of the food commodity to about the freezing temperature of the food commodity in a period of time of less than about 10 minutes.

20. A method of preserving a food commodity comprising:
coating an exterior surface of the food commodity with antimicrobial chemicals; and
chilling the food commodity.

21. The method of claim 20, wherein chilling the food commodity comprises reducing the temperature of the food commodity from a processing temperature to about the freezing temperature of the food commodity in a period of time of less than about 10 minutes.

22. The method of claim 21, wherein the processing temperature comprises about room temperature, and wherein the period of time is about 1 to about 3 minutes.

23. The method of claim 20, wherein chilling the food commodity comprises reducing the temperature of the food commodity from room temperature to about 1° C. in a period of time of about 1 to about 3 minutes.

24. The method of claim 20, wherein chilling the food commodity comprises cryogenic chilling.

25. The method of claim 24, wherein cryogenic chilling comprises chilling with a liquefied gas selected from the group consisting of nitrogen, CO₂ and air.

26. The method of claim 20, wherein coating an exterior surface of the food commodity with antimicrobial chemicals comprises applying liquid chemicals to the exterior surface.

27. The method of claim 26, wherein applying liquid chemicals comprises applying liquid ozone.

28. The method of claim 26, wherein applying liquid chemicals comprises contacting the food commodity with chemicals comprising a compound including a halogen.

29. The method of claim 28, wherein applying liquid chemicals comprises contacting the food commodity with chemicals comprising a compound including chlorine.

30. The method of claim 26, wherein applying liquid chemicals comprises contacting the food commodity with chemicals comprising a compound including a phosphate group.

31. The method of claim 26, wherein applying liquid chemicals comprises contacting the food commodity with chemicals comprising hydrogen peroxide.

32. The method of claim 26, wherein applying liquid chemicals comprises contacting the food commodity with chemicals comprising an organic acid.

33. The method of claim 32, wherein applying liquid chemicals comprises contacting the food commodity with chemicals comprising lactic acid.

34. The method of claim 26, wherein applying liquid chemicals comprises contacting the food commodity with chemicals selected from the group consisting of nisin and lactate.
